(19) United States
(12) Patent Application Publication
(10) Pub. No.: US 2015/0185897 A1
(43) Pub. Date: Jul. 2, 2015

(54) DEVICE FOR THE SURFACE DIFFUSION OF ILLUMINATED IMAGES TO HUMAN SCALE

(71) Applicants: Pascal Bauer, (US); DIGITALARTI, Paris (FR)

(72) Inventor: Pascal Bauer, Paris (FR)

(73) Assignee: DIGITALARTI, Paris (FR)

(21) Appl. No.: 14/384,051

(22) PCT Filed: Mar. 8, 2013
(86) PCT No.: PCT/EP2013/054792

§ 371 Date: Dec. 19, 2014

(30) Foreign Application Priority Data
Mar. 9, 2012 (FR) 12/00712

(51) Int. Cl. G06F 3/042; G06F 3/041

(52) U.S. Cl. CPC G06F 3/042; G06F 3/0414

(57) ABSTRACT

According to one aspect, the invention relates to a device for the surface diffusion of illuminated images to human scale, said device comprising a set of sensors (3) which can detect a body or other object close to the device, and a set of point light sources (2) which allow illuminated images to be diffused in response to the signals detected by the sensors. The device is characterised in that it comprises: a first set of plates or strips (1) on which point light sources and integrated circuits (4) for addressing the point light sources, either individually or in groups, are arranged in one or more lines, said integrated circuits being electrically connected in order to operate in a cascade manner in each line; and a second set of plates or strips (7) on which sensors (3) and integrated circuits (5) for addressing the sensors, either individually or in groups, are arranged in one or more lines, said integrated circuits being electrically connected in order to operate in a cascade manner in each line.

### TECHNICAL FIELD OF THE INVENTION

The present invention relates to a device and a method for the diffusion of illuminated images to human scale, for example video images, in response to interactions with bodies or other objects with the device.

### PRIOR ART

Known embodiments of devices diffusing video images to human scale, and capable of interacting with bodies or objects, include conventional video screen installations, or video projection installations, comprising cameras which sense, inter alia, body heat. The presence of these cameras and projectors entails a complexity of installation and a lack of freedom in the use of these devices. Furthermore, the interaction is based on vision by the camera and not on the touch or presence of the bodies.

Touch-based interactivity remains the domain of smaller installations comprising multi-touch systems, for example. Published patent applications US2006/0138983 and US2006/0097975 thus describe display screens including sensors sensitive to light and to touch. The devices described use liquid crystal technology (LCD). In the devices described, the light dots and sensors are arranged at the intersection of rows and columns for addressing.

Installations exist which are implemented on the basis of conventional screens protected by heavy glass plates on which the public can walk. Sensing is then effected, as on many multi-touch screens, optically, by a light emitted in the edge of the protective glass.

The subject-matter of the invention is a device and a method for the diffusion of illuminated images to human scale, capable of reacting to the presence of a body, and on surfaces that may be complex-volume, notably double-curvature-volume, surfaces.

### SUMMARY OF THE INVENTION

According to a first aspect, the invention relates to a device for the surface diffusion of illuminated images to human scale comprising a set of sensors suitable for detecting a body or other object close to the device and a set of dot light sources, for example LEDs, enabling the diffusion of the illuminated images in response to the signals detected by the sensors.

More precisely, the device comprises:
a first set of plates or strips on which the dot light sources and integrated circuits are arranged according to one or more rows for addressing the dot light sources individually or in groups, the integrated circuits being electrically connected to operate in cascade mode on each row,
a second set of plates or strips on which the sensors and integrated circuits are arranged according to one or more rows for addressing the sensors individually or in groups, the integrated circuits being electrically connected to operate in cascade mode on each row.

The integrated circuits advantageously comprise shift registers.

Arrangements according to a row is understood in the present description to mean that the dot light sources on the one hand and the sensors on the other hand are arranged behind one another, the row being able to follow any given path.

More precisely, a row according to the present description corresponds to a physical arrangement of dot light sources or sensor elements, addressed individually or in groups by integrated circuits which operate in cascade mode. This physical row of elements is not necessarily a straight line. Its path is physically arranged to create the surface that composes the image. For the diffusion of images, and, for example, video images, there may be only one single row of elements, light sources or sensors. The set of integrated circuits, for addressing the dot light sources on the one hand and for addressing the sensors on the other hand then operates in cascade mode. Alternatively, there may be a plurality of rows. In this case, the diffusion of the images may be effected successively on the different rows, only the integrated circuits of one row operating in cascade mode.

The device described in the present invention thus generates an image on a surface composed of physically dissociated rows. These surfaces can then be applied to multiple-curvature, for example double-curvature, complex volumes.

Furthermore, due to the operation in cascade mode on each row of the integrated circuits, the device described enables the bespoke production or the development of a display system comprising a number of displayed and sensed dots. It suffices in fact to connect the element(s) to be added to the row of existing elements and to develop the programming which redistributes the information on the rows.

The plates or strips can be flexible or rigid. They may be made up of layers of different materials on which the electrical and electronic circuits can be arranged, comprising the LEDs, sensors and integrated circuits. They will be referred to as electronic strips. One part of the integrated circuits enables an adjustment of the color and luminous intensity to be applied to the LEDs. Another part of the integrated circuits, arranged on the same strips or on adjacent strips, for example, enables the transmission of the information originating from the sensors. The sensors are advantageously pressure sensors, luminous intensity sensors which may be sensitive, for example, to the shadow generated by a body or other object, infrared sensors or other heat-sensitive sensors, capacitive or resistive sensors or a combination of these different sensors. The transmission of the information emitted by the sensors is implemented sequentially by a set of integrated circuits advantageously comprising shift registers which identify the sensors individually and contribute to the communication of their status or their situation to the computing system by working in cascade in relation to one another.

The device according to the invention thus implements a flexible or hard surface, diffusing illuminated images, for example video images, to human scale or larger. These images can be generated interactively with the bodies present or contacts with the surface, without this device requiring an extreme complexity of installation, through simple electrical connection or data connection to a computing system. This device can be installed horizontally or vertically or can adapt to volume shapes.

According to one variant, the sensors are pressure sensors and comprise first and second electrical contacts arranged on parallel, opposite surfaces which are intended to be placed in contact through the pressing of a body or other object on the device. Advantageously, the first contacts are arranged on a surface of the first strips or plates and the second contacts are arranged on a surface opposite the second strips or plates.

According to one variant, the dot light sources, the sensors and the set of integrated circuits are arranged in a row on the same plates or strips.

According to one variant, one or more of the dot light source elements, sensors and integrated circuits are integrated into a single electronic component.

The device advantageously comprises one or more substrate layers to support and protect the electronic strips, enabling the weight of a body to be received with ease.

Among the substrate layers that make up the device, a generally flat base layer, for example, can be mentioned, which is intended to be in contact with the ground or a vertical partition or any other shape, a support grid protecting the electronic elements from a pressure and a transparent elastomer substrate, diffusing the light of the LEDs and allowing the application of a residual pressure sensed by the detectors.

The base is advantageously deformable, generally flat, made from a rigid or semi-rigid material, intended to integrate the first and second sets of plates or strips and comprising a set of supports more or less perpendicular to the plane of the base and a set of flexible segments allowing the base to be deformed according to two directions of the plane. According to one example, the support grid has supports intended to rest on the supports of the base and openings intended to allow the passage of the light emitted by the dot light sources. According to one example, when the sensors are pressure sensors, the device furthermore comprises a flexible, transparent or translucent elastomer plate, intended to rest on the support grid and comprising pins to enter the openings of the support grid in such a way that a part of a pressure force applied to the device is transmitted to the sensors.

According to a second aspect, the invention relates to an interactive system for the diffusion of illuminated images to human scale, for example video images, comprising a device for the surface diffusion of illuminated images according to the first aspect and a computer system to which the device is connected in order to receive the information on the illuminated images to be diffused according to signals detected by the sensors.

According to a third aspect, the invention relates to a method for the surface diffusion of illuminated images to human scale, comprising:
the detection by means of sensors of a body or other object close to the device, the sensors being arranged in a row on plates or strips and electronically addressed individually or in groups by means of integrated circuits operating in cascade mode on one or more of the rows,
the emission of the illuminated images by means of dot light sources, in response to the signals detected by the sensors, the dot light sources being arranged in a row on plates or strips and being electronically addressed individually or in groups by means of integrated circuits operating in cascade mode on one or more of the rows.

### DESCRIPTION OF THE FIGURES

This and other aspects of the present invention will now be described more precisely with reference to the drawings which follow and which illustrate a currently preferred embodiment.

FIG. 1 shows the inventive device seen from above and in a three-quarter view with at least a part of its constituent elements embedded in one another.

FIG. 2 shows the inventive device seen from above and in a three-quarter view with an offset of its constituent elements in successive layers unembedded from one another.

FIG. 3 shows the electronic strips of the device according to the invention viewed from above and in a three-quarter view, separated from one another.

FIG. 4 shows the electronic strips of the device according to the invention viewed from below and in a three-quarter view, separated from one another.

### DESCRIPTION OF EXAMPLE EMBODIMENTS

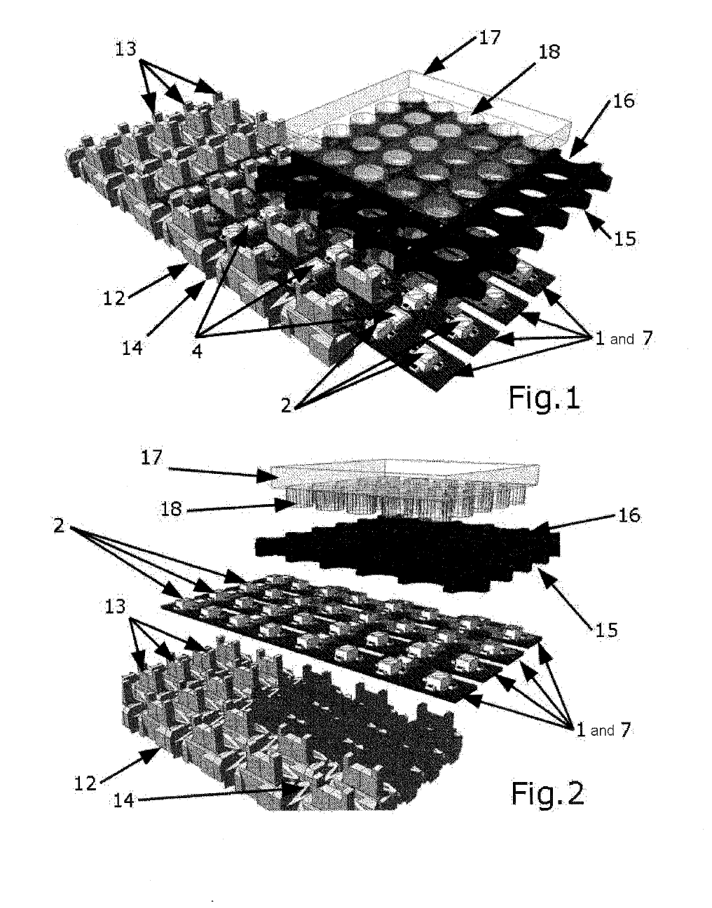

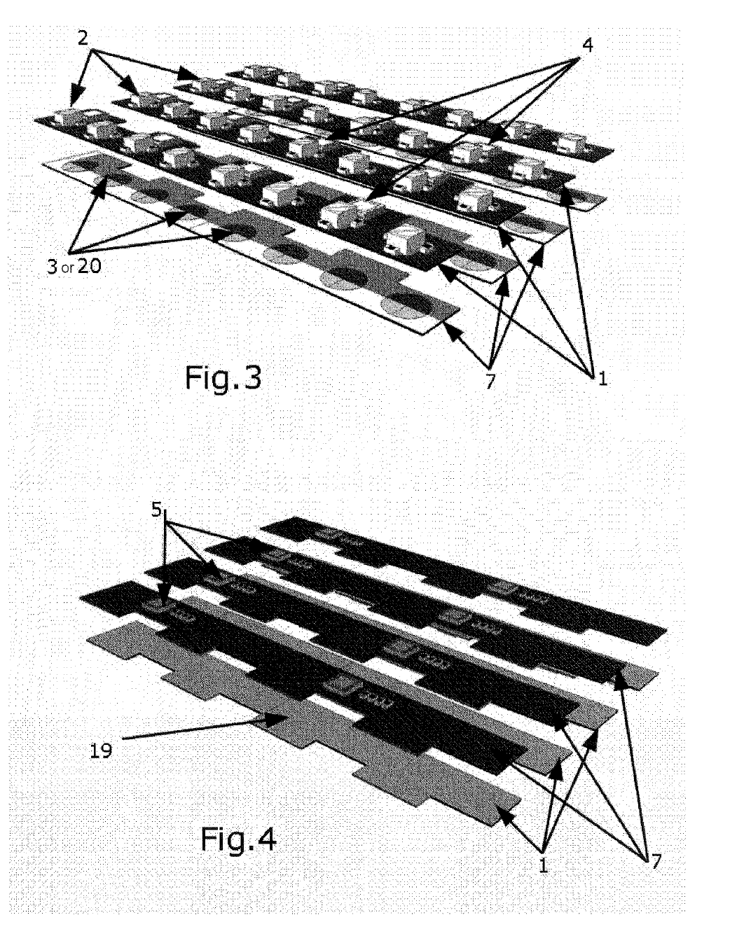

FIG. 1, FIG. 2, FIG. 3 and FIG. 4 show the inventive device according to one embodiment.

With reference to these drawings, the device, intended to be connected to an electrical power supply and to a computer system, comprises one or more flexible or rigid electronic plates or strips 1 on which a plurality of types of electronic elements are electrically connected. The electronic elements comprise dot light sources 2 which are LEDs or a different type of dot light sources and integrated circuits 4 which are shift registers which address the LEDs individually or in groups and apply an adjustment of color and intensity to them, enabling the LED to display video images.

A video image is, for example, converted by a suitable data processing program of a computer into a data stream comprising color and intensity display information of the light dots then transmitted to a controller. The controller converts it into a data stream adapted to the shift registers. A data stream of a row corresponds to an image; it is refreshed a large number of times per second. Each data stream is therefore sent in a single information packet to a series of shift registers disposed according to a row. The “data row” thus made up is transmitted to all of the shift registers, from shift register to shift register, each shift register retaining only the fragments of information which are intended for it and which it will use to control the display of the light points which it controls on this row. Once all of the shift registers are informed, an instruction is sent which controls the lighting of the light points according to the received display information, thus causing the complete display of the image. This physical row of LEDs, shift registers and other electronics is not necessarily in a straight line. Its path is physically arranged in order to recreate the surface which recomposes the image. It is possible to proceed with the data processing and the physical arrangement of this system into a single row or into a plurality of rows. In the case of a plurality of rows, successive display of the different rows can be implemented.

Sensors 3 which will emit an electrical signal when the detection work is in progress are also electrically connected to the electronic strips 1 or to other electronic strips 7 which are below or alongside. These sensors are, for example, pressure sensors, electromagnetic radiation sensors, capacitive or inductive sensors or more generally any type of sensor capable of detecting the contact presence of a body or other object. Integrated circuits 5 which are shift registers which address the sensors 3 individually or in groups and contribute to the communication to the computer system of their status and their situation by working in cascade mode in relation to one another are also electrically connected to the electronic strips 1 or to the electronic strips 7 in such a way that the computer system can precisely locate the sensors 3 and know their status.

Like the dot light sources, the sensors are arranged in a row on a support capable of making up an electronic circuit, for example the electronic strips. The path of this row is physically arranged to recreate a surface. Shift registers intended to address the sensors individually or in groups, and operating in cascade mode, are installed in series on this same support. These shift registers can operate in a plurality of ways according to the type of information transmitted by the sensors.

According to a first variant, the information may be of the all-or-nothing type (physical contact switch, for example). In this case, each shift register receives as much sensor information as it has inputs, stores this information and transmits it to the next shift register when it is instructed to do so.

According to a second variant, the information transmitted by the sensors is analog information. This may involve, for example, a luminous intensity sensor. In this case, Analog Digital Converters (ADC) are installed on the same physical row as the sensors and shift registers. Each Analog Digital Converter (ADC) can receive the analog value of one or more sensors according to its number of inputs. The Analog Digital Converters (ADC) are interrogated in turn by the controller at the time when the shift register corresponding to them selects them and transmits information on the status of the sensors to which they are connected. The shift registers and the ADCs can be combined within the same integrated circuit. The detection surface thus developed enables the implementation of a true cartography of affected points on the surface, for example in the form of a gray-scale image. It is possible to proceed with the data processing and the physical arrangement of this system in a single row or in a plurality of rows. In the case of a plurality of rows, successive sensing of the different rows can be implemented.

The assembly thus makes up a surface equipped with sensors and LEDs enabling the diffusion of a video image in relation to the signals emitted by the sensors which are precisely located by the system. The video image may thus be a video film or animation image calculated by a computer system which can be modified according to the signals emitted by the sensors. For example, the video image may start when a hand passes close to the surface, etc.

According to this example, the device comprises a base 12 implemented in a rigid or semi-rigid material comprising vertical supports 13, or more generally perpendicular to the plane of the base 12, intended to support elements serving to protect and diffuse the light emitted by the LEDs, flexible segments which allow this base to be deformed in two directions. This space receives the strips and can therefore be deformed to assume the shapes on which it is fixed.

According to this example, the device furthermore comprises a support grid 15 implemented in a rigid, semi-rigid, or flexible material which rests on the vertical supports 13 and which comprises openings 16 to allow the light of the LEDs 2 to pass through. This support grid 15 recovers the forces of a pressure that would be exerted on the device and transfers them to the vertical supports 13.

According to this example, the device furthermore comprises a transparent or translucent flexible elastomer plate 17 which rests on the support grid 15 and which comprises pins 18 entering the openings 16 in such a way that most of the forces of a pressure that would be exerted on the device end up on the grid 16 and that a residual part of these forces is applied to the LEDs 2 via the pins 18.

According to one particular embodiment, the device comprises pressure sensors 3, in the proximity of the LEDs 2, for example below, on the same strips 1 or on other strips 7. These pressure sensors emit information on an effective pressure on the integrated circuits 5, when a residual force is exerted on the LEDs 2 by means of the pins 18, the integrated circuits 5 sending the pressure information and the location of the latter to the computer system. The diffusion of a video image on the surface which is the subject-matter of the invention may be effected notably in correspondence with the presence of individuals or other objects in contact with the surface.

The pressure sensors 3 comprise, for example, a current-carrying path 19 present under the electronic strip 1 or on another support, and conductor wafers 20 present on the electronic strip 7 below the LEDs 2, in such a way that, when a residual force is applied to the LEDs 2 by means of the pin 18, the current-carrying path 19 comes into contact with the conductor wafers 20 connected to the integrated circuits 5 which will send the information on the pressure and its location to the computer system.

According to one variant, the electronic strips may be consolidated to form one strip only, in such a way that the sensors can be considered as membrane contactors or switches.

According to another variant, the sensors 3 can be placed on the same surface as the LEDs 2 and can be light wave intensity, infrared or visible light sensors, transmitting an analog value. In this case, the integrated circuits 5 are in the form of one or two different elements, comprising a combination of an Analog Digital Converter (ADC) and a shift register. Each Analogue Digital Converter (ADC) can receive the analog value of one or more sensors 3 according to its number of inputs. Each shift register can control one or more Analog Digital Converters (ADC). The Analog Digital Converters (ADC) transmit the information on the status of the sensors to which they are connected when they are interrogated in turn by a controller at the time when the shift register corresponding to them selects them.

According to one variant, the strips 1 are wider and are partially superimposed on one another in such a way that the LEDs can be placed on one side of the strip and the electronic elements other than the LEDs can be placed on the other side of the strip on the part of the strip that will be hidden by another strip which will partially overlap it. In this way, the LEDs can be brought close to one another in the longitudinal direction of the strip because there are no longer any components which separate them, and in the lateral direction of the strip because the strips overlap and partially cover one another. As the same strip 1 comprises in itself the functions of the strip 7, the same sensing systems 3, 19 and 20 can be installed there between the parts of strips which overlap one another.

The assembly thus made up forms a deformable surface equipped with sensors and LEDs enabling the diffusion of an image, for example a video image, in relation to the signals emitted by the sensors. p Although described by way of a certain number of example embodiments, the device and the method for the diffusion of images described in the present description may comprise different variants, modifications and refinements which will appear in an obvious manner to the person skilled in the art, on the understanding that these different variants, modifications and refinements form part of the scope of the invention as defined by the claims which follow.

1. A device for the surface diffusion of illuminated images to human scale comprising:
a set of sensors suitable for detecting a body or other object close to the device;
a set of dot light sources enabling the diffusion of the illuminated images in response to the signals detected by the sensors;
a first set of plates or strips on which the dot light sources and integrated circuits are arranged according to one or more rows for addressing the dot light sources individually or in groups, the integrated circuits being electrically connected to operate in cascade mode on each row; and
a second set of plates or strips on which the sensors and integrated circuits are arranged according to one or more rows for addressing the sensors individually or in groups, the integrated circuits being electrically connected to operate in cascade mode on each row.

2. The device as claimed in claim 1, wherein the integrated circuits comprise shift registers.

3. The device as claimed in claim 1, wherein the sensors are visible radiation or infrared sensors, capacitive or inductive sensors.

4. The device as claimed in claim 1, wherein the sensors are pressure sensors.

5. The device as claimed in claim 4, wherein the sensors comprise first and second electrical contacts arranged on parallel, opposite surfaces which are intended to be placed in contact through the pressing of a body or other object on the device.

6. The device as claimed in claim 5, wherein, the first and second sets of plates or strips being separate and arranged in more or less parallel planes, the first contacts are arranged on a surface of the first strips or plates and the second contacts are arranged on a surface opposite the second strips or plates.

7. The device as claimed in claim 1, wherein the dot light sources, the sensors and the set of integrated circuits are arranged according to one or more rows on the same plates or strips.

8. The device as claimed in claim 1, further comprising a deformable, generally flat base, made from a rigid or semi-rigid material, intended to integrate the first and second sets of plates or strips and comprising a set of supports more or less perpendicular to the plane of the base and a set of flexible segments allowing the base to be deformed according to two directions of said plane.

9. The device as claimed in claim 8, further comprising a support grid intended to rest on the supports of the base and openings intended to allow the passage of the light emitted by the dot light sources.

10. The device as claimed in claim 9, wherein, the sensors being pressure sensors, it furthermore comprises a flexible, transparent or translucent elastomer plate, intended to rest on the support grid and comprising pins to enter the openings of the support grid in such a way that a part of a pressure force applied to the device is transmitted to said sensors.

11. The device as claimed in claim 1, wherein the dot light sources are LEDs.

12. An interactive system for diffusing illuminated images to human scale comprising:
a device for the surface diffusion of illuminated images as claimed in claim 1; and
a computer system to which the device is connected in order to receive the information on the illuminated images to be diffused according to the signals detected by the sensors.

13. The interactive system as claimed in claim 12, wherein the illuminated images to be diffused are video images.

14. A method for the surface diffusion of illuminated images to human scale, comprising:
detection by means of sensors of a body or other object close to the device, the sensors being arranged according to one or more rows on plates or strips and electronically addressed individually or in groups by means of integrated circuits operating in cascade mode on each row; and
emission of the illuminated images by means of dot light sources, in response to the signals detected by the sensors, the dot light sources being arranged according to one or more rows on plates or strips and being electronically addressed individually or in groups by means of integrated circuits operating in cascade mode on each row.
